(19) United States
(12) Patent Application Publication
(10) Pub. No.: US 2025/0227315 A1
(43) Pub. Date: Jul. 10, 2025

(54) LIVE STREAMING MATERIAL PUBLISHING AND APPLYING

(71) Applicant: Beijing Youzhuju Network Technology Co., Ltd., Beijing (CN)

(72) Inventors: Xiao Wang, Beijing (CN); Hui Wang, Beijing (CN); Rong Zhao, Beijing (CN); Xuan Jiang, Beijing (CN); Tingting Bu, Beijing (CN); Wubo Cai, Beijing (CN); Jiangyu Zhu, Beijing (CN); Haixu Zhai, Beijing (CN); Hui Liao, Beijing (CN); Meng Zhang, Beijing (CN); Jincen Long, Beijing (CN); Lang Gong, Beijing (CN); Jiguang Wu, Beijing (CN); Xiaojie Wang, Beijing (CN); Shuai Shao, Beijing (CN); Zehuan Yuan, Beijing (CN)

(21) Appl. No.: 18/981,300

(22) Filed: Dec. 13, 2024

(30) Foreign Application Priority Data
Dec. 15, 2023 (CN) 202311738068.5

(51) Int. Cl. H04N 21/2187

(52) U.S. Cl. CPC H04N 21/2187

(57) ABSTRACT

Embodiments of the invention relates to a method, apparatus, device and storage medium for live streaming material publishing and applying. The method for live streaming material publishing including: obtaining description information regarding a live streaming material; providing a group of candidate live streaming materials generated based on the description information; and publishing a live streaming material set including at least one live streaming material determined from the group of candidate live streaming materials. Based on the above manner, the embodiments of the disclosure can efficiently generate and publish the live streaming material meeting the needs of the live streaming party, and improve the live streaming efficiency.

### CROSS-REFERENCE

The present application claims priority to Chinese Patent Application No. 202311738068.5, filed on Dec. 15, 2023 and entitled “METHOD, APPARATUS, DEVICE AND STORAGE MEDIUM FOR LIVE STREAMING MATERIAL PUBLISHING AND APPLYING”, the entirety of which is incorporated herein by reference.

### FIELD

Example embodiments of the present disclosure generally relate to the field of computers, and in particular, to live streaming material publishing and applying.

### BACKGROUND

With the development of computer technologies, the Internet has become an important source for people to obtain various contents. With the rapid development of the live streaming technology for content dissemination by using the Internet and the streaming media technology, people can interact with various types through a live streaming room, and obtain information with rich types through a live streaming room.

### SUMMARY

In a first aspect of the present disclosure, a method for live streaming material publishing is provided. The method comprising: obtaining description information regarding a live streaming material; providing a group of candidate live streaming materials generated based on the description information; and publishing a live streaming material set, wherein the live streaming material set comprises at least one live streaming material determined from a group of candidate live streaming materials.

In a second aspect of the present disclosure, a method for live streaming material applying is provided. The method comprising: obtaining a live streaming material set, wherein the live streaming material set comprises a group of live streaming materials generated based on the description information regarding the live streaming material; and applying at least one live streaming material in the live streaming material set to the target live streaming room.

In a third aspect of the present disclosure, an apparatus for live streaming material publishing is provided. The apparatus comprises an information obtaining module configured to obtain description information regarding a live streaming material; a material providing module configured to provide a group of candidate live streaming materials generated based on the description information; and a material publishing module configured to publish a live streaming material set, wherein the live streaming material set comprises at least one live streaming material determined from a group of candidate live streaming materials.

In a fourth aspect of the present disclosure, an apparatus for live streaming material applying is provided. The apparatus comprises a material obtaining module, wherein the material obtaining module is configured to obtain a live streaming material set, and the live streaming material set comprises a group of live streaming materials generated based on description information regarding the live streaming material; and a material application module is configured to apply at least one live streaming material in the live streaming material set to the target live streaming room.

In a fifth aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect or the second aspect.

In a sixth aspect of the present disclosure, a computer-readable storage medium is provided. The computer-readable storage medium stores a computer program, and the computer program is executable by the processor to implement the method according to the first aspect or the second aspect.

It should be understood that what is described in this content section is not intended to limit the key features or important features of the embodiments of the present disclosure, nor is it intended to limit the scope of the present disclosure. Other features of the present disclosure will become easily understandable from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numerals represent the same or similar elements, wherein:

FIG. 1 illustrates a schematic diagram of an example environment in which embodiments according to the present disclosure can be implemented;

FIG. 2 illustrates an example interface according to some embodiments of the present disclosure;

FIG. 3A illustrates a flowchart of an example process of live streaming material publishing according to some embodiments of the present disclosure;

FIG. 3B illustrates a flowchart of an example process of live streaming material applying according to some embodiments of the present disclosure;

FIG. 4A illustrates a schematic structural block diagram of an apparatus for live streaming material publishing according to some embodiments of the present disclosure;

FIG. 4B illustrates a schematic structural block diagram of an apparatus for live streaming material applying according to some embodiments of the present disclosure; and

FIG. 5 illustrates a block diagram of an electronic device in which various embodiments of the present disclosure can be implemented.

### DETAILED DESCRIPTION

Embodiments of the present disclosure will be described in more detail below with reference to the accompanying drawings. Although some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding relevant laws and regulations and related regulations. In the embodiments of the present disclosure, all data is collected, obtained, handled, processed, forwarded, used, etc., all of which are performed on the premise that the user knows and confirms. Accordingly, when implementing the embodiments of the present disclosure, the types, the usage scope, the usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As introduced above, live streaming has become an important form of Internet interaction. People may, for example, initiate a live streaming and become a main streamer of a live streaming room. Alternatively, people may also join another live streaming room to obtain corresponding live streaming content.

In a live streaming process, for example, an streamer may, look at a live streaming room, such as, configuring a virtual background for a live streaming room, thereby creating a better live streaming atmosphere. However, according to the traditional scheme, the streamer needs to configure the live streaming material one by one, which needs to consume more time cost and learning cost of the streamer.

In view of this, embodiments of the present disclosure provide a solution for live streaming material publishing and applying. According to the scheme, on one hand, description information regarding a live streaming material can be obtained; a group of candidate live streaming materials is provided, and the group of candidate live streaming materials at least comprises a group of candidate background materials generated based on description information; and a live streaming material set is published, and the live streaming material set comprises at least one background material determined from a group of candidate background materials.

In another aspect, the live streaming material set can be obtained including a group of background materials generated based on the description information regarding the live streaming material; and the live streaming material set is applied to the target live streaming room, so that the target live streaming room presents the target background material in the group of background materials.

Based on the above manner, the embodiments of the present disclosure can efficiently generate and publish the live streaming material meeting the needs of the live streaming party, and improve the live streaming efficiency.

Various example implementations of this scheme are described in detail below in conjunction with the accompanying drawings.

### Example Environment

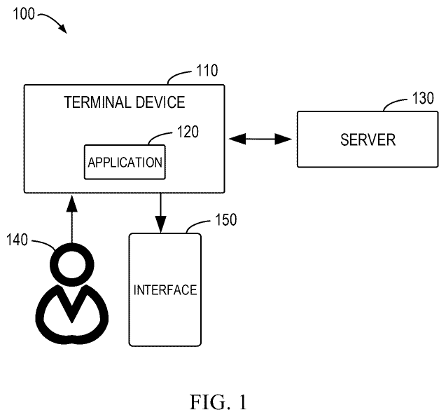

FIG. 1 illustrates a schematic diagram of an example environment 100 in which embodiments of the present disclosure can be implemented. As shown in FIG. 1, the example environment 100 may include a terminal device 110.

In this example environment 100, the terminal device 110 may run an application 120 for providing, viewing media content. The application 120 may be any suitable type of application for providing, viewing media content, examples of which may include, but are not limited to, online video applications, live applications. The user 140 may interact with the application 120 via the terminal device 110 and/or its attachment device. The user 140 may, for example, a user providing the live content (also referred to as a streamer), a user viewing the live streaming (also referred to as a spectator).

In the example environment 100 of FIG. 1, if the application 120 is active, the terminal device 110 may present the live interface 150 through the application 120.

In some embodiments, the terminal device 110 communicates with server 130 to enable provisioning of services to application 120. The terminal device 110 may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio streaming receiver, an electronic book device, a game device, or any combination thereof, including accessories and peripherals of these devices, or any combination thereof. In some embodiments, the terminal device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 that supports the virtual scene in the terminal device 110.

A communication connection may be established between the server 130 and the terminal device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the terminal device 110 may implement signaling interaction by using a communication connection between the server 130 and the terminal device 110.

It should be understood that the structures and functions of the various elements in the example environment 100 are described for exemplary purposes only and do not imply any limitation to the scope of the present disclosure.

Some example embodiments of the present disclosure will be described below with continued reference to the accompanying drawings.

### Example Interface

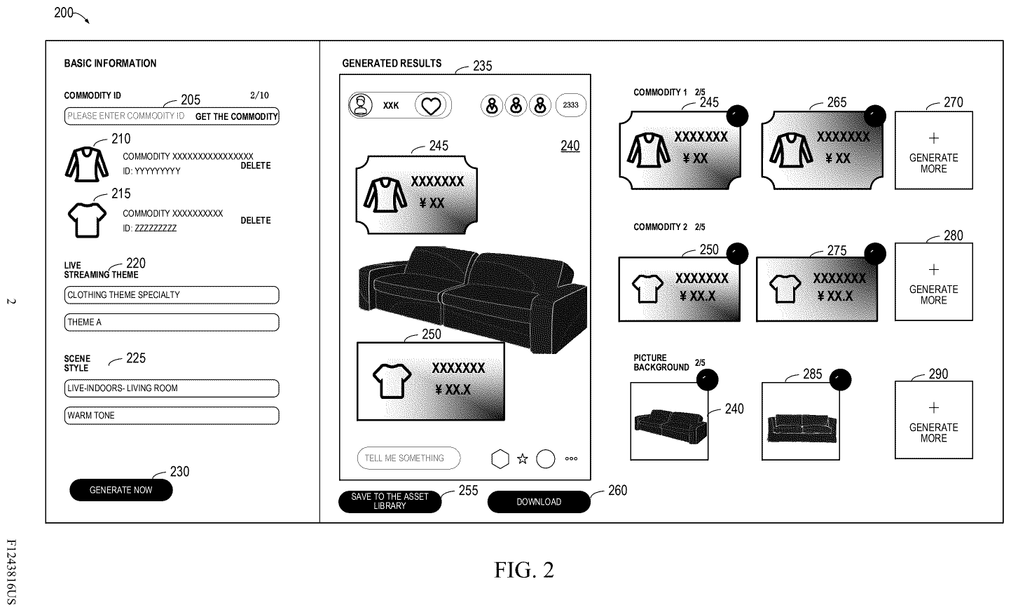

Some example embodiments of the present disclosure will be described below with continued reference to the accompanying drawings. FIG. 2 illustrates an example interface 200 according to some embodiments of the present disclosure, that interface 200 may be provided by a terminal device 110 associated with a user 140 (e.g., a streamer user) of a live streaming room. The interface 200 may be an interface for generating and publishing materials.

As shown in FIG. 2, the interface 200 may include an information input area, configured to obtain description information for generating a live streaming material from a user.

In some embodiments, the description information may be used to indicate at least one object associated with the live streaming room. Specifically, the terminal device 110 may obtain the identification information of the at least one object through the object input control 205 in the information input area. As an example, such objects may include, for example, commodity objects for promotion or sale in a live streaming room.

As shown in FIG. 2, the user 140 may add the commodity object 210 and the commodity object 215 by inputting the identifier of the commodity object in the object input control 205.

In some embodiments, the terminal device 110 may further obtain configuration information regarding the live streaming theme of the live streaming room through the theme input control 220.

In addition, the terminal device 110 may further obtain style description information regarding the live streaming background of the live streaming room, for example, by using the style input control 220. For example, the user 140 may input style description information of the background, including “live-indoors-living room” and “warm tone”.

In some embodiments, such style description information may, for example, indicate a scene style of a live streaming background of the live streaming room, for example, a living room. Additionally or alternatively, such style description information may also indicate, for example, a color style, e.g., a warm tone, of a live background of the live streaming room.

In some embodiments, such style description information may be, for example, selected from a set of predetermined candidate items. For example, the terminal device 110 may provide a set of predetermined scene styles or a set of predetermined color styles for user to select.

As another example, the user may also describe the scene style and/or the color style desired by the user through natural language text.

Further, as shown in FIG. 2, the terminal device 110 may provide a group of candidate live streaming materials for the live streaming room based on the description information obtained from the information input area. For example, the terminal device 110 may receive a trigger operation of the user on the button 230, so as to correspondingly provide the corresponding candidate live streaming material.

As an example, such candidate live streaming material may include candidate background materials, for example, candidate background materials 240, generated based on the description information.

In still other embodiments, such candidate live streaming material may further include candidate object materials corresponding to at least one object specified by the user (for example, the commodity object 210 and the commodity object 215), for example, the candidate object material 245 and the candidate object material 250.

In some embodiments, candidate live streaming materials may include one or more of the following: a picture background of the live streaming room, a video background of the live streaming room, a commodity material of the live streaming room, a patch material of the live streaming room, and a title bar material of the live streaming room.

The generation process of the candidate live streaming material will be described below.

In some embodiments, the terminal device 110 and/or the server 130 may utilize the model to generate a corresponding candidate live streaming material based on the description information.

As an example, the terminal device 110 and/or the server 130 may generate the guidance information to the target model based on the description information (for example, the information regarding the commodity object and/or the style description information discussed above). In some embodiments, such a target model may be implemented based on an appropriate machine learning model, such as an image generation model or a video generation model.

As an example, such guidance information may be used to instruct the target model to generate a corresponding candidate background material, for example, a picture background or a video background, according to the style description information.

As another example, such guidance information may be used, for example, to instruct the target model to generate the corresponding candidate background material according to the object information (for example, the commodity information).

Further, the terminal device 110 and/or the server 130 may obtain a group of candidate background materials generated by the target model based on the guidance information. Taking FIG. 2 as an example, the candidate background material 240 may be generated based on “live-indoors-living room” and “warm tone”, for example. As still another example, the target model may also generate a matched candidate background material based on the color or style of the commodity object.

In some embodiments, the candidate object material 245 provided or the candidate object material 250 provided may have a pattern matching the received description information. For example, the candidate object material 245 and the candidate object material 250 may have a corresponding color style, e.g., “warm tone”.

In some embodiments, the terminal device 110 and/or the server 130 may generate the candidate object material based on the object information associated with the specified object.

Taking the commodity object 210 and the commodity object 215 as examples, the terminal device 110 and/or the server 130 may obtain object information of the commodity object 210 and the commodity object 215, and such object information may include, for example, image information and text information of the commodity object.

Further, the terminal device 110 and/or the server 130 may determine a group of resources for generating the object material based on the object information. For example, the terminal device 110 and/or the server 130 may extract the image resource based on processing such as keying a product image of the commodity object. As another example, the terminal device 110 and/or the server 130 may summarize based on the text introduction of the commodity object, to obtain the text resource.

It should be understood that the terminal device 110 and/or the server 130 may, for example, process the object information by using an appropriate machine learning model, to obtain the resource used to generate the candidate object material.

Further, the terminal device 110 and/or the server 130 may use the determined group of resources to generate at least one candidate object material, for example, the candidate object material 245 and the candidate object material 250.

In some embodiments, the terminal device 110 and/or the server 130 may, for example, generate at least one candidate object material by using a group of resources according to predetermined material template information. For example, using the candidate object material 245 as an example, the terminal device 110 and/or the server 130 may obtain a set of predetermined material templates, and fill the determined resources into the template, to generate corresponding candidate object materials.

In some embodiments, such a set of predetermined material templates may, for example, correspond to a set of predetermined patterns. For example, different material templates may correspond to different color patterns, for example, warm tones, cold tones, and the like. As still another example, different material templates may also correspond to different shape styles, content layout patterns, and so on.

In some embodiments, the candidate object material 245 and the candidate object material 250 provided by the terminal device 110 may, for example, have a pattern corresponding to the color style “warm tone”.

In still other embodiments, the pattern of the candidate object material 245 and the candidate object material 250 may also be determined based on the candidate background material 240 generated. For example, the terminal device 110 may provide the candidate object material 245 and the candidate object material 250 that match the color style of the candidate background material 240.

Based on such a manner, embodiments of the present disclosure can provide a candidate live streaming material with a uniform style.

In some embodiments, as shown in FIG. 2, the terminal device 110 may further present a live streaming preview interface 235. The live streaming preview interface 235 may be configured to display a display effect of at least one candidate live streaming material in a group of candidate live streaming materials in a live streaming room, for example, an effect of the candidate object material 245, the candidate object material 250, and the candidate background material 240.

Based on this manner, the embodiments of the present disclosure can help the user feel the application effect of the live streaming material more intuitively, thereby facilitating the user to determine whether the live streaming material needs to be further edited or modified.

In some embodiments, as shown in FIG. 2, the terminal device 110 may provide a plurality of candidate live streaming materials. For example, the commodity object 210 and the terminal device 110 may provide the candidate object material 245 and the candidate object material 265. As an example, the terminal device 110 may further provide a generation portal 270, and may provide one or more additional candidate object materials corresponding to the commodity object 210 based on the selection of the generation portal 270.

Similarly, the terminal device 110 may further provide another candidate object material 275 corresponding to the commodity object 215, and provide a generation portal 280 for generating the additional candidate object material.

Additionally, as shown in FIG. 2, the terminal device 110 may also provide candidate background materials 285, and provide a generation portal 290 for generating additional candidate background materials.

In some embodiments, the terminal device 110 may update the live streaming preview interface 235 based on the user's selection of the candidate live streaming material in the plurality of provided candidate live streaming materials, to show the display effect of the selected candidate live streaming material.

In still other embodiments, the terminal device 110 may further receive a user selection of one or more candidate live streaming materials from the plurality of provided candidate live streaming materials, and may further publish a corresponding live streaming material set.

As an example, the user may, for example, save the selected live streaming material to the asset library corresponding to the user through the button 255. As another example, the user may also download the selected live streaming material locally to the terminal device 110 through the button 260.

In some embodiments, after the live streaming material set is published (for example, saved to a cloud asset library or downloaded to the local), the terminal device 110 corresponding to the user or another appropriate user may further apply the published live streaming material set.

Specifically, the terminal device 110 may obtain a published live streaming material set, for example, the live streaming material set may be published based on the foregoing process. As an example, such a live streaming material set includes a group of background materials that may be generated based on the description information regarding the live streaming material.

Further, the terminal device 110 applies the live streaming material set to the target live streaming room, so that the target live streaming room presents the target background material in the group of background materials. For example, when the live streaming material set includes a plurality of available background materials, the terminal device 110 may receive a user selection of a target background material (for example, a picture background or a video background), and apply such target background material to the live streaming room to be configured.

In still other embodiments, in addition to the picture background or the video background, the live streaming material set may also include, for example, a commodity material of the live streaming room, a patch material of the live streaming room, a title bar material of the live streaming room, and the like. The user can select the corresponding live streaming material and apply the live streaming material to the target live streaming room, thereby completing the decoration of the target live streaming room.

Based on the process described above, embodiments of the present disclosure can efficiently generate and publish live streaming material meeting requirements of a live streaming party, and can support to apply such live streaming material to a specific live streaming room. In this way, the embodiments of the present disclosure can reduce the time cost and the learning cost of the live streaming room of the streamer, and can improve the uniformity of the style of the live streaming room.

### Example Process

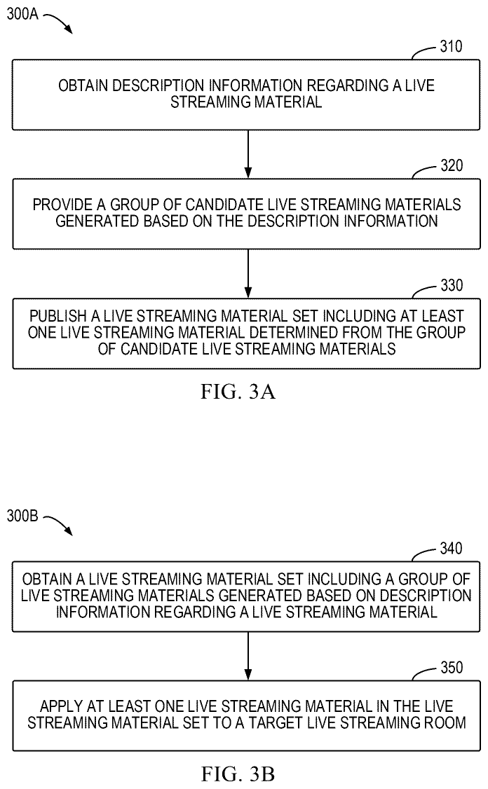

FIG. 3A illustrates a flowchart of a process 300A for live streaming material publishing according to some embodiments of the present disclosure. Process 300A may be implemented at terminal device 110. Process 300A is described below with reference to FIG. 1.

As shown in FIG. 3A, at block 310, the terminal device 110 obtains description information regarding the live streaming material.

At block 320, the terminal device 110 provides a group of candidate live streaming materials generated based on the description information.

In block 330, the terminal device 110 publishes a live streaming material set, where the live streaming material set includes at least one live streaming material determined from a group of candidate live streaming materials.

In some embodiments, the group of candidate live streaming materials includes a group of candidate background materials for the live streaming room, and the group of candidate background materials includes a picture material or a video material.

In some embodiments, the description information indicates at least one of the following: at least one object associated with the live streaming room; a scene style of the live streaming background of the live streaming room; a color style of the live streaming background of the live streaming room.

In some embodiments, the group of candidate background materials is generated based on the following process: generating guidance information to the target model based on the description information; and obtaining a group of candidate background materials generated by the target model based on the guidance information.

In some embodiments, the description information indicates at least one object associated with the live streaming room, and providing the group of candidate live streaming materials includes: providing at least one candidate object material corresponding to the at least one object, the at least one candidate object material having a pattern matching the description information.

In some embodiments, the process 300A further includes: providing a group of additional candidate object materials corresponding to the at least one object based on the received predetermined operation.

In some embodiments, the at least one candidate object material is generated based on: obtaining object information corresponding to the at least one object; determining a group of resources for generating the object material based on the object information; and generating at least one candidate object material by using the group of resources.

In some embodiments, the group of resources includes image resources and/or text resources associated with at least one object.

In some embodiments, the generating at least one candidate object material by using a group of resources includes: generating at least one candidate object material by using a group of resources according to predetermined material template information.

In some embodiments, the predetermined material template information corresponds to a predetermined pattern.

In some embodiments, the process 300A further includes: presenting a live streaming preview interface, where the live streaming preview interface is used to display a display effect of at least one of the group of candidate live streaming materials in the live streaming room.

In some embodiments, the published live streaming material set includes at least one of: a picture background of the live streaming room, a video background of the live streaming room, a commodity material of the live streaming room, a patch material of the live streaming room, or a title bar material of the live streaming room.

FIG. 3B illustrates a flowchart of a process 300B of live streaming material applying according to some embodiments of the present disclosure. Process 300B may be implemented at terminal device 110. Process 300B is described below with reference to FIG. 1.

As shown in FIG. 3B, in block 340, the terminal device 110 obtains a live streaming material set, where the live streaming material set includes a group of live streaming materials generated based on the description information regarding the live streaming material.

In block 350, the terminal device 110 applies at least one live streaming material in the live streaming material set to the target live streaming room.

In some embodiments, the live streaming material set includes at least one of the following: a picture background of the live streaming room, a video background of the live streaming room, a commodity material of the live streaming room, a patch material of the live streaming room, or a title bar material of the live streaming room.

### Example Apparatus and Device

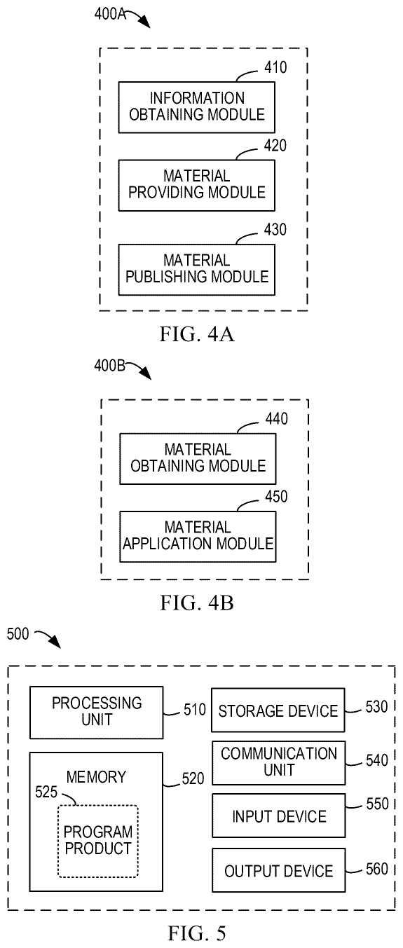

Embodiments of the present disclosure also provide a corresponding apparatus for implementing the above method or process. FIG. 4A illustrates a schematic structural block diagram of an apparatus 400A for live streaming material publishing according to some embodiments of the present disclosure. The apparatus 400A may be implemented or included in the terminal device 110. The various modules/components in the apparatus 400A may be implemented by hardware, software, firmware, or any combination thereof.

As shown in FIG. 4A, the apparatus 400A includes an information obtaining module 410, configured to obtain description information regarding a live streaming material; a material providing module 420, configured to provide a group of candidate live streaming materials generated based on the description information; and a material publishing module 430, configured to publish a live streaming material set, where the live streaming material set includes at least one live streaming material determined from the group of candidate live streaming materials.

In some embodiments, the group of candidate live streaming materials includes a group of candidate background materials for the live streaming room, and the group of candidate background materials includes a picture material or a video material.

In some embodiments, the description information indicates at least one of the following: at least one object associated with the live streaming room; a scene style of the live streaming background of the live streaming room; a color style of the live streaming background of the live streaming room.

In some embodiments, the group of candidate background materials is generated based on the following process: generating guidance information to the target model based on the description information; and obtaining a group of candidate background materials generated by the target model based on the guidance information.

In some embodiments, the description information indicates at least one object associated with the live streaming room, and the material providing module 420 is further configured to provide at least one candidate object material corresponding to the at least one object, the at least one candidate object material having a pattern matching the description information.

In some embodiments, the material providing module 420 is further configured to provide a group of additional candidate object materials corresponding to the at least one object based on the received predetermined operation.

In some embodiments, the at least one candidate object material is generated based on: obtaining object information corresponding to the at least one object; determining a group of resources for generating the object material based on the object information; and generating at least one candidate object material by using the group of resources.

In some embodiments, the group of resources includes image resources and/or text resources associated with at least one object.

In some embodiments, the generating at least one candidate object material by using a group of resources includes: generating at least one candidate object material by using a group of resources according to predetermined material template information.

In some embodiments, the predetermined material template information corresponds to a predetermined pattern.

In some embodiments, the apparatus 400A further includes a preview module configured to: present a live streaming preview interface, where the live streaming preview interface is used to display a display effect of at least one candidate live streaming material in a group of candidate live streaming materials in a live streaming room.

In some embodiments, the published live streaming material set includes at least one of: a picture background of the live streaming room, a video background of the live streaming room, a commodity material of the live streaming room, a patch material of the live streaming room, or a title bar material of the live streaming room.

Embodiments of the present disclosure also provide a corresponding apparatus for implementing the above method or process. FIG. 4B illustrates a schematic structural block diagram of an apparatus 400B for live streaming material applying according to some embodiments of the present disclosure. The apparatus 400B may be implemented or included in the terminal device 110. The various modules/components in the apparatus 400B may be implemented by hardware, software, firmware, or any combination thereof.

As shown in FIG. 4B, the apparatus 400B includes: a material obtaining module 440, configured to obtain a live streaming material set, where the live streaming material set includes a group of live streaming materials generated based on the description information regarding the live streaming material; and a material application module 450, configured to apply at least one live streaming material in the live streaming material set to the target live streaming room.

In some embodiments, the published live streaming material set includes at least one of: a picture background of the live streaming room, a video background of the live streaming room, a commodity material of the live streaming room, a patch material of the live streaming room, or a title bar material of the live streaming room.

FIG. 5 illustrates a block diagram of an electronic device 500 in which one or more embodiments of the present disclosure can be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the terminal device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines, these computing machines are capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable storage medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart and/or block diagram. These computer-readable program instructions may also be stored in a computer-readable medium that cause the computer, programmable data processing apparatus, and/or other devices to function in a particular manner, such that the computer-readable storage medium storing instructions includes an article of manufacture including instructions to implement aspects of the functions/acts specified in one or more blocks in the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for live streaming material publishing, comprising:
obtaining description information regarding a live streaming material;
providing a group of candidate live streaming materials generated based on the description information; and
publishing a live streaming material set including at least one live streaming material determined from the group of candidate live streaming materials.

2. The method of claim 1, wherein the group of candidate live streaming materials comprises a group of candidate background materials for a live streaming room, and the group of candidate background materials comprises a picture material or a video material.

3. The method of claim 2, wherein the description information indicates at least one of:
at least one object associated with the live streaming room,
a scene style of a live streaming background of the live streaming room, or
a color style of the live streaming background of the live streaming room.

4. The method of claim 2, wherein the group of candidate background materials is generated based on:
generating guidance information to a target model based on the description information; and
obtaining the group of candidate background materials generated by the target model based on the guidance information.

5. The method of claim 1, wherein the description information indicates at least one object associated with a live streaming room, and providing the group of candidate live streaming materials comprises:
providing at least one candidate object material corresponding to the at least one object, the at least one candidate object material having a pattern matching the description information.

6. The method of claim 5, further comprising:
providing a group of additional candidate object materials corresponding to the at least one object based on a received predetermined operation.

7. The method of claim 5, wherein the at least one candidate object material is generated based on:
obtaining object information corresponding to the at least one object;
determining a group of resources for generating an object material based on the object information; and
generating the at least one candidate object material by using the group of resources.

8. The method of claim 7, wherein the group of resources comprises an image resource and/or a text resource associated with the at least one object.

9. The method of claim 7, wherein generating the at least one candidate object material by using the group of resources comprises:
generating the at least one candidate object material by using the group of resources according to predetermined material template information.

10. The method according to claim 9, wherein the predetermined material template information corresponds to a predetermined pattern.

11. The method of claim 1, further comprising:
presenting a live streaming preview interface, the live streaming preview interface being configured to display a display effect of at least one candidate live streaming material in the group of candidate live streaming materials in a live streaming room.

12. The method of claim 1, wherein the published live streaming material set comprises at least one of:
a picture background of a live streaming room,
a video background of the live streaming room,
a commodity material of the live streaming room,
a patch material of the live streaming room, or
a title bar material of the live streaming room.

13. An electronic device, comprising:
at least one processing unit; and
at least one memory, coupled to the at least one processing unit and storing instructions for execution by the at least one processing unit, the instructions, when executed by the at least one processing unit, causing the electronic device to perform operations comprising:
obtaining description information regarding a live streaming material;
providing a group of candidate live streaming materials generated based on the description information; and
publishing a live streaming material set including at least one live streaming material determined from the group of candidate live streaming materials.

14. The device of claim 13, wherein the group of candidate live streaming materials comprises a group of candidate background materials for a live streaming room, and the group of candidate background materials comprises a picture material or a video material.

15. The device of claim 14, wherein the description information indicates at least one of:
at least one object associated with a livestreaming room,
a scene style of a live streaming background of the live streaming room, or
a color style of the live streaming background of the live streaming room.

16. The device of claim 14, wherein the group of candidate background materials is generated based on:
generating guidance information to a target model based on the description information; and
obtaining the group of candidate background materials generated by the target model based on the guidance information.

17. The device of claim 13, wherein the description information indicates at least one object associated with a live streaming room, and providing the group of candidate live streaming materials comprises:
providing at least one candidate object material corresponding to the at least one object, the at least one candidate object material having a pattern matching the description information.

18. The device of claim 17, wherein the operations further comprise:
providing a group of additional candidate object materials corresponding to the at least one object based on a received predetermined operation.

19. The device of claim 17, wherein the at least one candidate object material is generated based on:
obtaining object information corresponding to the at least one object;
determining a group of resources for generating an object material based on the object information; and
generating the at least one candidate object material by using the group of resources.

20. A non-transitory computer-readable storage medium, storing a computer program, the computer program being executable by a processor to implement a method comprising:
obtaining description information regarding a live streaming material;
providing a group of candidate live streaming materials generated based on the description information; and
publishing a live streaming material set including at least one live streaming material determined from the group of candidate live streaming materials.
